(19) United States
(12) Patent Application Publication
(10) Pub. No.: US 2026/0004986 A1
(43) Pub. Date: Jan. 1, 2026

(54) Electrical Circuit Breaker Device

(71) Applicant: PACIFIC ENGINEERING CORPORATION, Gifu (JP)

(72) Inventors: Naoki Yamamura, Gifu (JP); Akihiko Shimizu, Gifu (JP)

(73) Assignee: PACIFIC ENGINEERING CORPORATION, Gifu (JP)

(21) Appl. No.: 18/870,198

(22) PCT Filed: May 1, 2023
(86) PCT No.: PCT/JP2023/016995

§ 371 Date: Sep. 5, 2025

(30) Foreign Application Priority Data
Jul. 1, 2022 (JP) 2022-106771

(51) Int. Cl. H01H 85/36

(52) U.S. Cl. CPC H01H 85/36

(57) ABSTRACT

The present invention provides an electric circuit breaker device capable of suppressing an increase in power of a power source and easily cutting off an electric circuit while it is possible to cope with an increase in the number of parts to be cut (fuse elements). An electric circuit breaker device includes an accommodation portion, external connection terminals at both sides, a fuse element accommodated in the accommodation portion, and an arc-extinguishing material, wherein the electric circuit breaker device includes a power mechanism configured to apply a tensile force to an end portion of the fuse element to divide the fuse element, and an electrical connection maintaining structure maintaining an electrical connection between the fuse element and the external connection terminal until the fuse element is divided.

### TECHNICAL FIELD

The present invention relates to an electric circuit breaker device that can be mainly used for an electric circuit of an automobile or the like.

### BACKGROUND ART

In the related art, an electric circuit breaker device has been used to protect an electric circuit mounted on an automobile or the like and various electric components connected to the electric circuit. Specifically, when an abnormality occurs in the electric circuit, the electric circuit breaker device disconnects part of the electric circuit to physically cut off the electric circuit.

There are various types of electric circuit breaker devices. For example, the electric circuit breaker device of Patent Literature 1 includes a housing, a part to be cut (fuse element) that is disposed in the housing and constitutes part of an electric circuit, a power source that is disposed at a first end portion of the housing, and a moving body that moves in the housing between the first end portion and a second end portion opposite to the first end portion. While the moving body is moved by the power source from the first end portion toward the second end portion, part of the moving body cuts off the part to be cut to cut off the electric circuit.

Since a voltage and a current applied to an electric circuit tend to increase due to recent improvement in performance of automobiles and the like, a plurality of parts to be cut (fuse elements) may be used accordingly. However, since the moving body is required to cut the plurality of parts to be cut (fuse elements), the number of cutting places increases, and the area, of the arc-extinguishing material accommodated inside, to be sheared increases. Then, it is necessary to increase the power for cutting the part to be cut by the moving body, and as a result, it is necessary to further improve the strength of the housing so as to withstand the increased power (explosive power of the gunpowder or the like). In addition, there is a problem that the housing is large and the size and price of the electric circuit breaker device increase accordingly.

### CITATION LIST

### Patent Literature

Patent Literature 1: Japanese Patent Application No. 2020-080298

### SUMMARY OF INVENTION

### Technical Problem

Therefore, in view of the above problems, the present invention provides an electric circuit breaker device capable of suppressing an increase in power of a power source and easily cutting off an electric circuit while it is possible to cope with an increase in the number of parts to be cut (fuse elements).

### Solution To Problem

An electric circuit breaker device according to the present invention includes an accommodation portion, external connection terminals at both sides, a fuse element accommodated in the accommodation portion, and an arc-extinguishing material, wherein the electric circuit breaker device includes a power mechanism configured to apply a tensile force to an end portion of the fuse element to divide the fuse element, and an electrical connection maintaining structure that maintains an electrical connection between the fuse element and the external connection terminals until the fuse element is divided.

According to the above feature, since the fuse element is divided by applying a tensile force to the fuse element, and the electric circuit is cut off, it is not necessary to shear the arc-extinguishing material together with the fuse element as in the conventional case.

Even when a plurality of fuse elements is provided, only the force for dividing the fuse elements increases, and the area, of the arc-extinguishing material, to be sheared does not increase unlike the conventional electric circuit breaker device. Therefore, the power of the power mechanism for generating the tensile force can be reduced, as compared with the conventional electric circuit breaker device. As a result, according to the electric circuit breaker device of the present invention, it is possible to suppress an increase in power of a power source and easily cut off the electric circuit while it is possible to cope with an increase in the number of parts to be cut (fuse elements).

In addition, the current flowing through the electric circuit can stably flow by the electrical connection maintaining structure until the end portion of the fuse element starts to move and the arc generated by dividing the fuse element is extinguished.

An electric circuit breaker device according to the present invention includes a movable portion coupled to an end portion of the fuse element, wherein the movable portion is moved by the power mechanism, and the movable portion moved applies a tensile force to an end portion of the fuse element to divide the fuse element.

According to the above feature, power can be efficiently transmitted to the end portion of the fuse element by the movable portion, and the fuse element can be efficiently divided.

In the electric circuit breaker device according to the present invention, the power mechanism includes a power source and a moving body that moves by power generated by the power source, and wherein the moving body moves the movable portion.

According to the above feature, the moving body can efficiently transmit power to the movable portion, and can efficiently divide the fuse element.

In the electric circuit breaker device according to the present invention, before the moving body moves, the moving body is away from the movable portion, and wherein after the moving body starts to move, the moving body comes into contact with the movable portion, and the movable portion moves.

According to the above feature, the moving body can be accelerated using the gap, and the moving body is sufficiently accelerated from the initial speed to the vicinity of the maximum speed at the moment when the moving body contacts the movable portion. Then, since the sufficiently accelerated moving body can instantaneously move the movable portion laterally, the fuse element coupled to the movable portion can also be instantaneously divided, and the electric circuit can be divided more quickly.

In the electric circuit breaker device of the present invention, the electrical connection maintaining structure includes facing clamping plates, and wherein the movable portion includes a slide portion that is movable between the clamping plates while being clamped from by the clamping plates both sides and being electrically connected.

According to the above feature, the electric current flowing through the electric circuit can reliably and stably flow by the electrical connection maintaining structure via the clamping plate until the end portion of the fuse element starts to move and the arc generated by dividing the fuse element is extinguished.

In the electric circuit breaker device according to the present invention, the slide portion includes a conductive portion electrically connectable to the clamping plates and an insulating portion adjacent to the conductive portion, and wherein the conductive portion is located between the clamping plates before the movable portion moves, and the insulating portion is located between the clamping plates after the movable portion moves.

According to the above feature, since the overcurrent (fault current) flowing from the external connection terminal and the clamping plate is cut off by the insulating portion, the arc generated immediately after the fuse element is cut off can be quickly extinguished.

In the electric circuit breaker device according to the present invention, the electrical connection maintaining structure includes a plastically deformable conductor, and wherein the conductor is coupled to the external connection terminal and the movable portion.

According to the above feature, according to the above feature, the current flowing through the electric circuit can reliably and stably flow by the electrical connection maintaining structure including the plastically deformable conductor until the end portion of the fuse element starts to move and the arc generated by dividing the fuse element is extinguished.

In the electric circuit breaker device according to the present invention, the accommodation portion accommodates a fastening portion for fastening and fixing the arc-extinguishing material, and wherein the power mechanism moves the fastening portion toward a periphery of a division portion of the fuse element to fasten and fix the arc-extinguishing material.

According to the above feature, when the fuse element is divided to cut off the overcurrent, the arc-extinguishing material that is again fastened by the fastening portion can effectively extinguish the arc generated at a periphery of the division portion.

In the electric circuit breaker device according to the present invention, the fuse element includes a narrow portion, and includes a tension assisting portion that concentrates the tensile force in and divides the narrow portion.

According to the above feature, the tension assisting portion can limit an any narrow portion as a division portion as designed, and the arc generated at the time of dividing can be efficiently extinguished.

### Advantageous Effects Of Invention

As described above, according to the electric circuit breaker device of the present invention, it is possible to suppress an increase in power of a power source and easily cut off the electric circuit while it is possible to cope with an increase in the number of parts to be cut (fuse elements).

### BRIEF DESCRIPTION OF DRAWINGS

FIG. 1 is an overall perspective view of an electric circuit breaker device of the present invention according to a first embodiment.

FIG. 2 is a plan view of the electric circuit breaker device.

FIG. 3(a) is a cross-sectional view taken along line A-A of FIG. 2, and FIG. 3(b) is a cross-sectional view taken along line B-B of FIG. 2.

FIG. 4 is a plan view illustrating a state in which the moving body has moved from the state illustrated in FIG. 2.

FIG. 5(a) is a cross-sectional view illustrating a state in which the fuse element is divided from the state illustrated in FIG. 3(a), and FIG. 5(b) is a cross-sectional view illustrating a state in which the moving body has moved from the state illustrated in FIG. 3(b).

FIG. 6 is an overall perspective view illustrating a power mechanism and an electrical connection maintaining structure of an electric circuit breaker device of the present invention according to the second embodiment in an exploded manner.

FIG. 7 is a plan view of the electric circuit breaker device.

FIG. 8(a) is a cross-sectional view taken along line C-C in FIG. 7, and FIG. 8(b) is a cross-sectional view taken along line D-D in FIG. 7.

FIG. 9 is a plan view illustrating a state in which the moving body has moved from the state illustrated in FIG. 7.

FIG. 10(a) is a cross-sectional view illustrating a state in which the fuse element is divided from the state illustrated in FIG. 8(a), and FIG. 10(b) is a cross-sectional view illustrating a state in which the moving body has moved from the state illustrated in FIG. 8(b).

FIG. 11 is an overall perspective view showing an electric circuit breaker device of the present invention according to the third embodiment in an exploded manner.

FIG. 12 is a plan view of the electric circuit breaker device in an assembled state.

FIG. 13(a) is a cross-sectional view taken along line E-E of FIG. 12, and FIG. 13(b) is a cross-sectional view taken along line F-F of FIG. 12.

FIG. 14 is a plan view illustrating a state in which the moving body has moved from the state illustrated in FIG. 12.

FIG. 15(a) is a cross-sectional view illustrating a state in which the fuse element is divided from the state illustrated in FIG. 13(a), and FIG. 15(b) is a cross-sectional view illustrating a state in which the moving body has moved from the state illustrated in FIG. 13(b).

FIG. 16 is a plan view of an electric circuit breaker device of the present invention according to the fourth embodiment.

FIG. 17 is an overall perspective view of the electromagnetic coil type tripping device of the power mechanism.

FIG. 18 is an enlarged plan view illustrating a power mechanism and a moving body of the electric circuit breaker device.

FIG. 19 is a plan view in which the moving body has moved from the state illustrated in FIG. 16.

FIG. 20 is an overall perspective view of an electric circuit breaker device of the present invention according to the fifth embodiment.

FIG. 21 is a cross-sectional view taken along line G-G in FIG. 20.

FIG. 22 is a plan view illustrating a state in which the moving body has moved from the state illustrated in FIG. 21.

FIG. 23 is a plan view illustrating a state in which the moving body further moves from the state illustrated in FIG. 22.

FIG. 24(a) is a side view of the fuse element of the present invention according to the sixth embodiment, FIG. 24(b) is a side view of the fuse element of the present invention according to the seventh embodiment, and FIG. 24(c) is a side view of the fuse element of the present invention according to the eighth embodiment.

FIG. 25 is a plan view of an electric circuit breaker device of the present invention according to the ninth embodiment.

FIG. 26 is a plan view illustrating a state in which the moving body has moved from the state illustrated in FIG. 25.

### REFERENCE SIGNS LIST

100 fuse element
110 end portion
200 accommodation portion
290 arc-extinguishing material
300 movable portion 3
900 electric circuit breaker device
910 external connection terminal
F tensile force

### DESCRIPTION OF EMBODIMENTS

Hereinafter, each embodiment of the present invention will be described with reference to the drawings. The shape, material, and the like of each member of the electric circuit breaker device according to the embodiment described below are merely examples, and are not limited thereto.

### First Embodiment

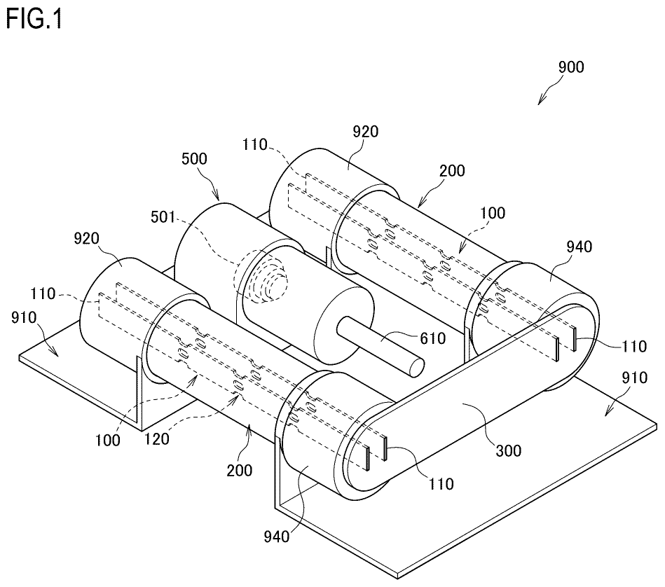

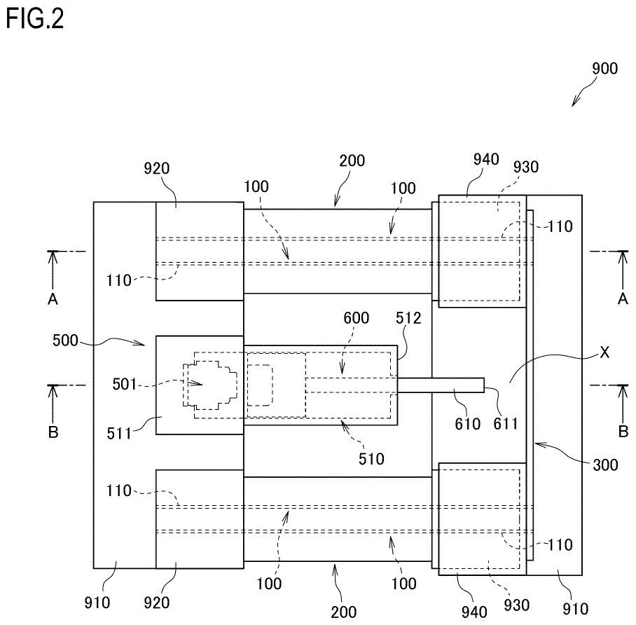

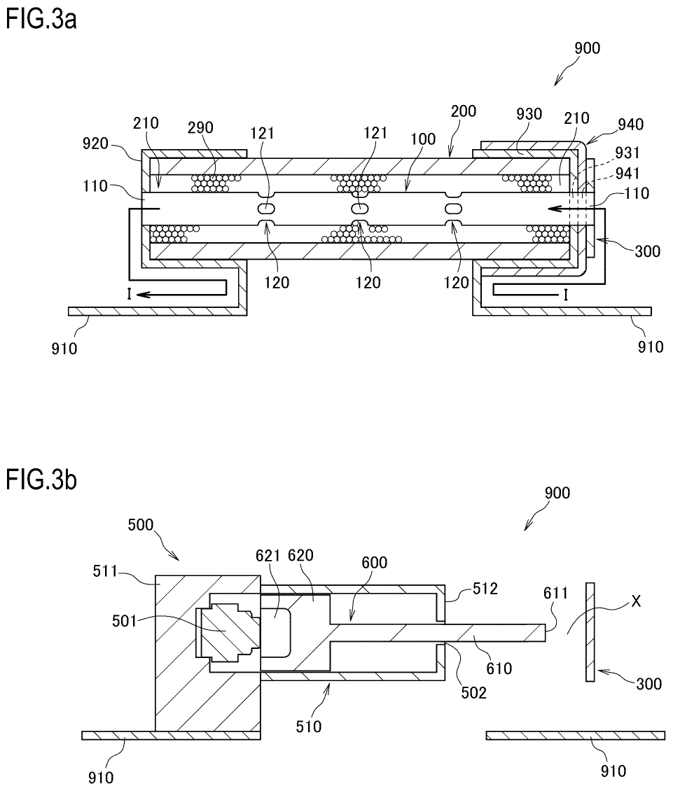

First, an electric circuit breaker device 900 according to the first embodiment of the present invention is illustrated in FIGS. 1 to 3. Note that FIG. 1 is an overall perspective view of the electric circuit breaker device 900, FIG. 2 is a plan view of the electric circuit breaker device 900, FIG. 3(a) is a cross-sectional view taken along line A-A of FIG. 2, and FIG. 3(b) is a cross-sectional view taken along line B-B of FIG. 2.

As shown in FIGS. 1 to 3, the electric circuit breaker device 900 includes external connection terminals 910 at both sides for electrically connecting to an external electric circuit. A plurality of fuse elements 100 electrically connected to the external connection terminals 910 at both sides is provided. Each fuse element 100 includes a single thin plate-shaped metal plate made of a metal conductor such as copper, and includes end portions 110 at both sides and a fusion portion 120 located between the end portions 110. As shown in FIG. 3(a), the fusion portion 120 has a plurality of small holes 121 in part of the fuse element 100 having a narrowed width to generate heat and blow when an unintended overcurrent flows in an electric circuit or the like to cut off the overcurrent.

Two fuse elements 100 are accommodated in each accommodation portion 200. The accommodation portion 200 has a tubular shape having openings 210 at each of both ends, and can be made of various materials such as ceramic and synthetic resin. Each fuse element 100 is accommodated in the accommodation portion 200, and the accommodation portion 200 is filled with a granular arc-extinguishing material 290. Although the accommodation portion 200 is filled with the granular arc-extinguishing material 290 without a gap, only part of the arc-extinguishing material 290 is illustrated in the drawing in consideration of visibility.

One opening 210 (left side in the drawing) of the accommodation portion 200 is closed by a cap 920 which is part of the external connection terminal 910. The cap 920 and the end portion 110 of the fuse element 100 are coupled and fixed to each other. Further, the end portion 110 of the fuse element 100 and the cap 920 of the external connection terminal 910 are electrically connected to each other. On the other hand, the other opening 210 (right side in the drawing) of the accommodation portion 200 is closed by an inner cap 930 which is part of the external connection terminal 910. The end portion 110 of the fuse element 100 passes through an insertion hole 931 provided in the inner cap 930 and protrudes outside the inner cap 930. The end portion 110 of the fuse element 100 is not coupled and fixed to the insertion hole 931 of the inner cap 930, and the end portion 110 of the fuse element 100 can slide with respect to the insertion hole 931 as described later.

An outer cap 940 made of metal is fitted to the outside of the inner cap 930. The outer cap 940 is configured to be slidable to the side while being fitted to the outside of the inner cap 930, and the outer cap 940 and the inner cap 930 are electrically connected to each other at the contact face even when sliding. The inner cap 930 and the outer cap 940 constitute an electrical connection maintaining structure that maintains an electrical connection between the fuse element 100 and the external connection terminal 910. The end portion 110 of the fuse element 100 passes through an insertion hole 941 provided in the outer cap 940 and protrudes outside the outer cap 940. The end portion 110 of the fuse element 100 is coupled and fixed to the insertion hole 941 of the outer cap 940, and is also electrically connected.

The end portion 110 of the fuse element 100 protruding outside the outer cap 940 is coupled and fixed to a movable portion 300. The movable portion 300 is an elongated metal plate member, and is electrically connected to the end portion 110 of each fuse element 100. The movable portion 300 and the outer cap 940 are also coupled and fixed, and are electrically coupled to each other. As the movable portion 300 moves laterally, the end portion 110 and the outer cap 940 of each fuse element 100 also move laterally integrally.

Next, a configuration of a power mechanism 500 will be described. The power mechanism 500 is a substantially cylindrical body formed of an insulator such as synthetic resin, and includes an accommodation portion 510 capable of accommodating a moving body 600 therein, and a power source 501 is provided at a first end portion 511 of the accommodation portion 510. In addition, an insertion hole 502 is provided at a second end portion 512 of the accommodation portion 510, and a protrusion 610 of the moving body 600 is inserted. The moving body 600 is formed of an insulator such as synthetic resin, and includes a sliding portion 620 that slides while contacting the inner face of the accommodation portion 510, and the protrusion 610 protruding laterally from the sliding portion 620. The sliding portion 620 is provided with a recess 621 so as to face the power source 501. As will be described in detail later, power such as air pressure generated from the power source 501 is transmitted to the moving body 600, and the moving body 600 moves from the first end portion 511 toward the second end portion 512 in the accommodation portion 510.

Then, the electric circuit breaker device 900 is attached in an electric circuit to be protected and used. Specifically, the external connection terminals 910 at both sides of the electric circuit breaker device 900 are connected to part of the electric circuit. In the normal state, the current I flowing from the electric circuit flows from the inner cap 930 to the outer cap 940 of the external connection terminal 910. Since the inner cap 930 and the outer cap 940 are firmly electrically connected, the current I reliably flows from the external connection terminal 910 to the outer cap 940. Since the outer cap 940 and the end portion 110 of the fuse element 100 are fixed, a current I flows from the outer cap 940 to the end portion 110 of the fuse element 100. Further, the current I flows from one end portion 110 (right side in the drawing) to the other end portion 110 (left side in the drawing) of the fuse element 100, and flows from the other end portion 110 to the external connection terminal 910 via the cap 920. In this way, in the normal state, the current I flows in the electric circuit via the electric circuit breaker device 900. In the normal state, the power mechanism 500 is not operated, and the moving body 600 is not moving. Therefore, a distal end 611 of the protrusion 610 of the moving body 600 is not in contact with the movable portion 300 and is in a separated state. In FIGS. 1 and 2, a total of four fuse elements 100 are coupled and fixed to the movable portion 300, but the present invention is not limited thereto. Only one fuse element 100 may be coupled and fixed to the movable portion 300, or any number of (two or more) fuse elements 100 may be coupled and fixed to the movable portion 300.

Here, for example, when a relatively high abnormal current flows in the electric circuit, the fusion portion 120 of the fuse element 100 of the electric circuit breaker device 900 generates heat and quickly blows, so that the electric circuit can be immediately cut off. On the other hand, when, for example, a relatively low abnormal current flows in the electric circuit, it takes time for the fusion portion 120 of the fuse element 100 of the electric circuit breaker device 900 to generate heat and blows, and there is a possibility that the electric circuit cannot be cut off immediately or the electric circuit cannot be cut off because the fusion portion 120 does not blow.

In this case, an external monitoring device detects that a relatively low abnormal current flows, and inputs an abnormal signal to the power source 501 of the power mechanism 500 of the electric circuit breaker device 900. When an abnormal signal is input from an external monitoring device, the power source 501 detonates powder inside the power source 501, for example, and instantaneously pushes out and moves the moving body 600 in the accommodation portion 510 by air pressure due to the explosion. Note that the power source 501 is not limited to a power source using gunpowder as long as it generates power for moving the moving body 600, and other known power sources may be used. In addition, an external monitoring device detects that a relatively low abnormal current flows, and inputs an abnormal signal to the power source 501 of the power mechanism 500 of the electric circuit breaker device 900, but the present invention is not limited thereto. Even when a relatively high abnormal current flows in the electric circuit, an external monitoring device may input an abnormal signal to the power mechanism 500 of the electric circuit breaker device 900, and in this case, the fuse element 100 is further divided after the fusion portion 120 of the fuse element 100 of the electric circuit breaker device 900 generates heat and blows, so that the electric circuit can be cut off more reliably and quickly. Not limited to the case of detecting a relatively low abnormal current, the external monitoring device may input an abnormal signal to the power mechanism 500 of the electric circuit breaker device 900 to divide the fuse element 100 when a predetermined abnormal current desired to be cut off flows.

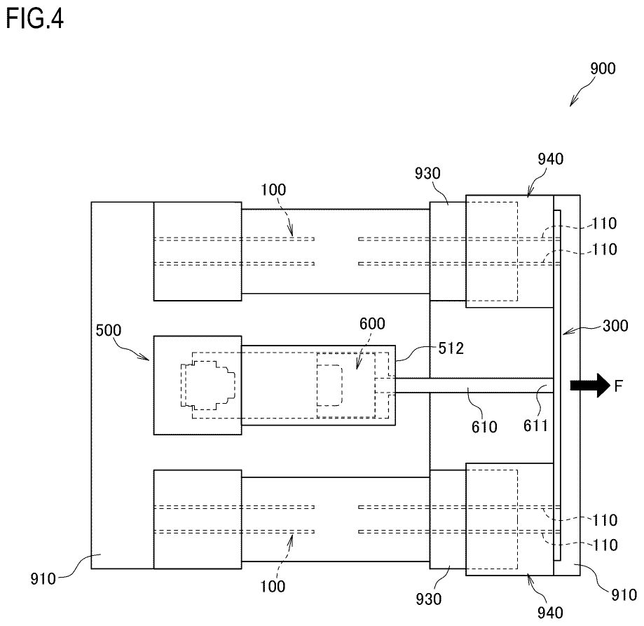

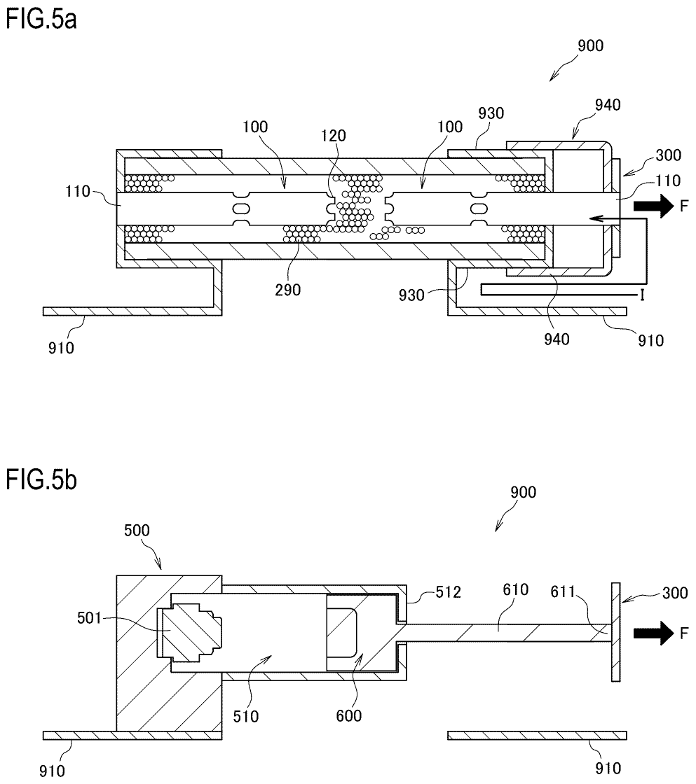

Then, the powder in the power source 501 explodes, and the air pressure due to the explosion is transmitted to the recess 621 of the moving body 600. Then, as illustrated in FIGS. 4 and 5, the moving body 600 is vigorously blown from the first end portion 511 toward the second end portion 512 by the air pressure, and instantaneously moves toward the second end portion 512 in the accommodation portion 510. FIG. 4 is a plan view illustrating a state in which the moving body 600 has moved from the state illustrated in FIG. 2, FIG. 5(a) is a cross-sectional view illustrating a state in which the fuse element 100 is divided from the state illustrated in FIG. 3(a), and FIG. 5(b) is a cross-sectional view illustrating a state in which the moving body 600 has moved from the state illustrated in FIG. 3(b).

As illustrated in FIGS. 4 and 5(b), when the moving body 600 moves toward the second end portion 512, the distal end 611 of the protrusion 610 of the moving body 600 contacts the movable portion 300. Then, the movable portion 300 is pressed by the moving body 600, and the entire movable portion 300 moves laterally. Then, since the end portion 110 of the fuse element 100 is coupled and fixed to the movable portion 300 at both sides of the movable portion 300, when the movable portion 300 moves laterally, the fuse element 100 coupled to the movable portion 300 is pulled laterally. Then, the fuse element 100 is physically divided into left and right portions by the tensile force F to cut off the overcurrent I. As a result, even when a relatively low abnormal current flows, the electric circuit can be immediately cut off regardless of the presence or absence of blowing of the fusion portion 120. Since the tensile force F concentrates on the fusion portion 120 where the width of the fuse element 100 is locally narrowed, the periphery of the fusion portion 120 is divided. The arc generated after dividing the fuse element 100 is effectively extinguished by the arc-extinguishing material 290.

As described above, according to the electric circuit breaker device 900 of the present invention, since the fuse element 100 is divided by applying a tensile force to the fuse element to cut off the electric circuit, it is not necessary to shear the arc-extinguishing material 290 together with the fuse element 100. Therefore, as compared with the case where the part to be cut and the arc-extinguishing material are cut by the moving body as in the conventional electric circuit breaker device, the force for cutting the fuse element 100 may be small, and the power of the power mechanism for generating the tensile force may also be small. Specifically, according to the electric circuit breaker device 900 of the present invention, even when a plurality of fuse elements 100 is provided, only the force for dividing the fuse elements 100 increases, and the area, of the arc-extinguishing material, to be sheared does not increase unlike the conventional electric circuit breaker device. Therefore, the power of the power mechanism for generating the tensile force can be reduced, as compared with the conventional electric circuit breaker device. As a result, according to the electric circuit breaker device 900 of the present invention, it is possible to suppress an increase in power of a power source and easily cut off the electric circuit while it is possible to cope with an increase in the number of parts to be cut (fuse elements).

When the fuse element 100 is pulled, the end portion 110 of the fuse element 100 slides in the insertion hole 931 of the inner cap 930 of the external connection terminal 910, so that the electrical connection between the fuse element 100 and the external connection terminal 910 is not stable. Further, since the end portion 110 of the fuse element 100 is configured to be slidable in the insertion hole 931 of the inner cap 930 of the external connection terminal 910, the electrical connection between the end portion 110 of the fuse element 100 and the inner cap 930 of the external connection terminal 910 may not be stable even in a state before the fuse element 100 is pulled.

However, as shown in FIG. 3(a), in a state before the fuse element 100 is pulled, the outer cap 940 firmly fits into the outer side of the inner cap 930 to firmly maintain a state of being in electrical and physical contact. Further, as shown in FIG. 5(b), even when the movable portion 300 moves and the end portion 110 of the fuse element 100 slides, the outer cap 940 moves laterally together with the movable portion 300, but the outer cap 940 and the inner cap 930 constituting the electrical connection maintaining structure are firmly fitted to each other to maintain a state of being in electrical and physical contact with each other. Therefore, the current I flows from the inner cap 930 to the outer cap 940 of the external connection terminal 910 until the end portion 110 of the fuse element 100 starts to move and the arc generated by dividing the fuse element 100 is extinguished, and then flows to the fuse element 100 coupled and fixed to the outer cap 940, so that the current can stably flow in the electric circuit.

As illustrated in FIGS. 2 and 3(b), in a state before the abnormal current flows and the power mechanism 500 operates, there is a gap X between the distal end 611 of the moving body 600 and the movable portion 300, and they are away from each other. Then, after the moving body 600 starts to move by the power generated by the power source 501, the distal end 611 of the moving body 600 comes into contact with the movable portion 300 to move the movable portion 300 as illustrated in FIG. 5(b). Therefore, the moving body 600 can be accelerated using the gap X, and at the moment when the moving body 600 contacts the movable portion 300, the moving body 600 is sufficiently accelerated from the initial speed to the vicinity of the maximum speed. Then, since the moving body 600 that has been sufficiently accelerated can instantaneously move the movable portion 300 laterally, the fuse element 100 coupled to the movable portion 300 can be instantaneously divided, and the electric circuit can be cut off more quickly. In the state before the power mechanism 500 operates, the gap X exists between the distal end 611 of the moving body 600 and the movable portion 300, and they are away from each other, but the present invention is not limited thereto. For example, even in a state before the power mechanism 500 operates, there may be no gap X between the distal end 611 of the moving body 600 and the movable portion 300, and the distal end 611 of the moving body 600 and the movable portion 300 may be in contact with each other. By using the moving body 600, the power generated by the power source 501 can be efficiently transmitted to the movable portion 300, and as a result, the fuse element 100 coupled to the movable portion 300 can be effectively and quickly divided.

### Second Embodiment

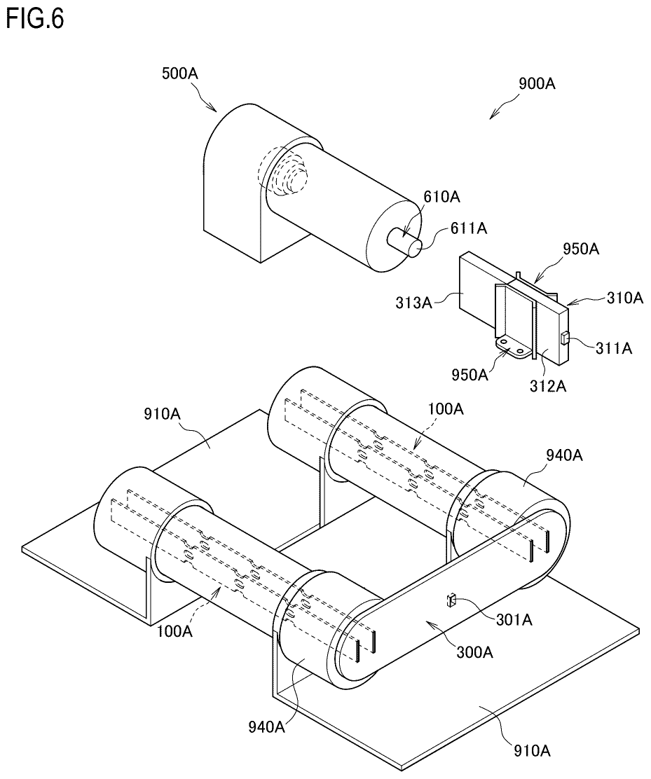

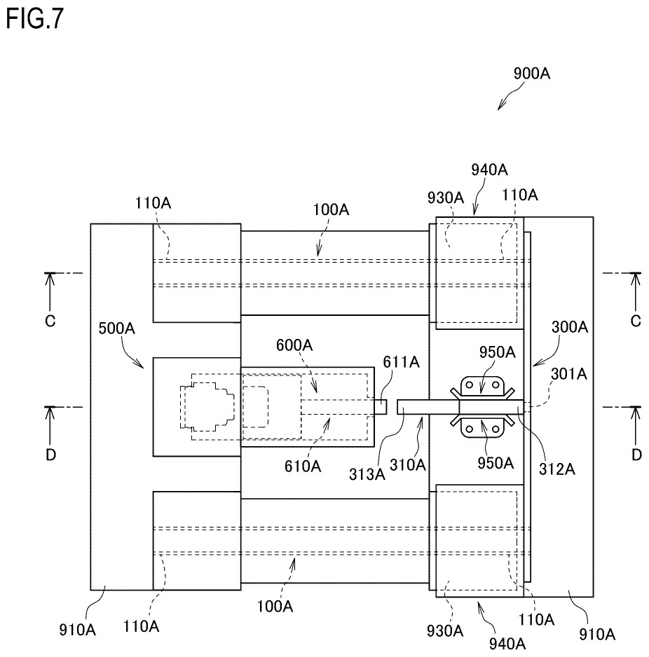

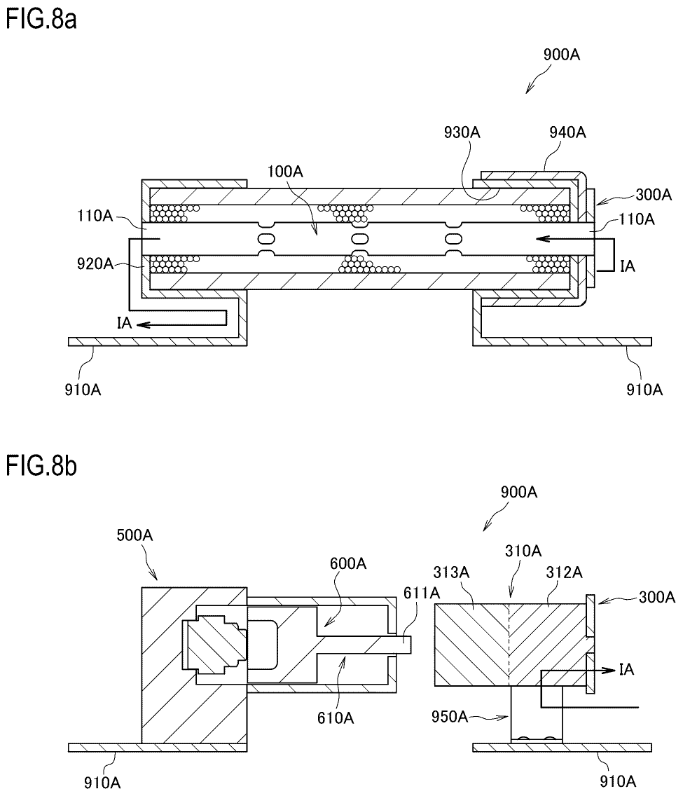

Next, an electric circuit breaker device 900A of the present invention according to the second embodiment will be described with reference to FIGS. 6 to 8. FIG. 6 is an overall perspective view illustrating a power mechanism 500A and the electrical connection maintaining structure of the electric circuit breaker device 900A, FIG. 7 is a plan view of the electric circuit breaker device 900A, FIG. 8(a) is a cross-sectional view taken along line C-C of FIG. 7, and FIG. 8(b) is a cross-sectional view taken along line D-D of FIG. 7. In addition, the configuration of the electric circuit breaker device 900A according to the second embodiment is different from the configuration of the electric circuit breaker device 900 according to the first embodiment in that the configuration of the electrical connection maintaining structure and a movable portion 300A include a slide portion 310A, but the other configurations are basically the same as the configuration of the electric circuit breaker device 900 according to the first embodiment, and thus the description of the same configurations is omitted.

The movable portion 300A includes the plate-like slide portion 310A, and a projection 310A of the slide portion 311A is fitted into a fixing hole 301A of the movable portion 300A, so that the slide portion 310A is firmly coupled and fixed to the movable portion 300A. Further, the slide portion 310A includes a metal conductive portion 312A and an insulating portion 313A, and the conductive portion 312A and the insulating portion 313A are coupled in an adjacent state. Although the movable portion 300A and the conductive portion 312A of the slide portion 310A are electrically connected to each other, the movable portion 300A and the insulating portion 313A are electrically insulated from each other.

A pair of clamping plates 950A is fixed to an external connection terminal 910A. The clamping plate 950A is made of metal, and slidably clamps the slide portion 310A. The clamping plate 950A is electrically connected to the conductive portion 312A of the slide portion 310A and the external connection terminal 910A. The clamping plate 950A constitutes an electrical connection maintaining structure that maintains an electrical connection between a fuse element 100A and the external connection terminal 910A.

An outer cap 940A is fitted to the outside of an inner cap 930A, and the outer cap 940A is configured to be slidable laterally while being fitted to the outside of the inner cap 930. Since the outer cap 940A is made of an insulator, the inner cap 930A and the outer cap 940A are not electrically connected. However, an end portion 110A, of the fuse element 100A, protruding outside the outer cap 940A is coupled and fixed to the movable portion 300A, and the fuse element 100A and the movable portion 300A are electrically connected.

The electric circuit breaker device 900A is attached to an electric circuit to be protected and used. Specifically, the external connection terminals 910A of the electric circuit breaker device 900A at both sides are connected to part of the electric circuit. In the normal state, a current IA flowing from the electric circuit flows from the external connection terminal 910A to the clamping plate 950A as illustrated in FIG. 8(b). Since the clamping plate 950A and the conductive portion 312A of the slide portion 310A are electrically connected, and the conductive portion 312A and the movable portion 300A are also electrically connected, the current IA reliably flows from the clamping plate 950A to the movable portion 300A via the conductive portion 312A. As illustrated in FIG. 8(a), since the movable portion 300A and the end portion 110A of the fuse element 100A are fixed, the current IA flows from the movable portion 300A to the end portion 110A of the fuse element 100A. Further, the current IA flows from the one end portion 110A to the other end portion 110A of the fuse element 100A, and flows from the other end portion 110A to the external connection terminal 910A via a cap 920A.

In this way, the current IA flows in the electric circuit via the electric circuit breaker device 900A. In the normal state, the power mechanism 500A does not operate, and a moving body 600A does not move. Therefore, a distal end 611A of a protrusion 610A of the moving body 600A is not in contact with the insulating portion 313A of the slide portion 310A of the movable portion 300A and is in a separated state.

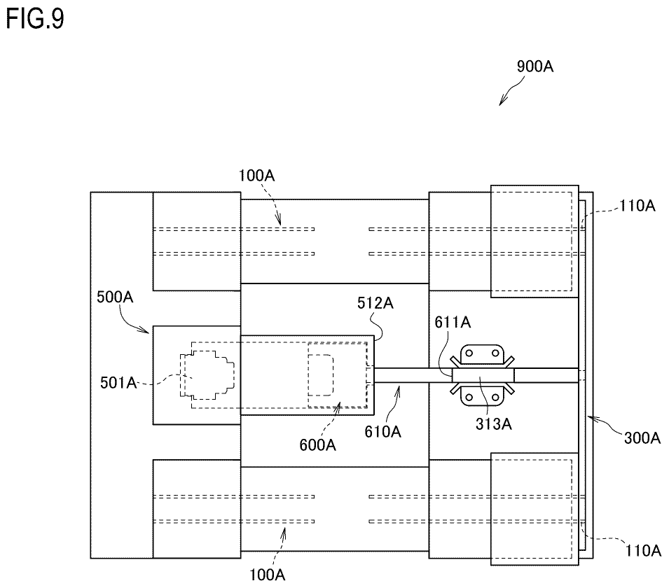

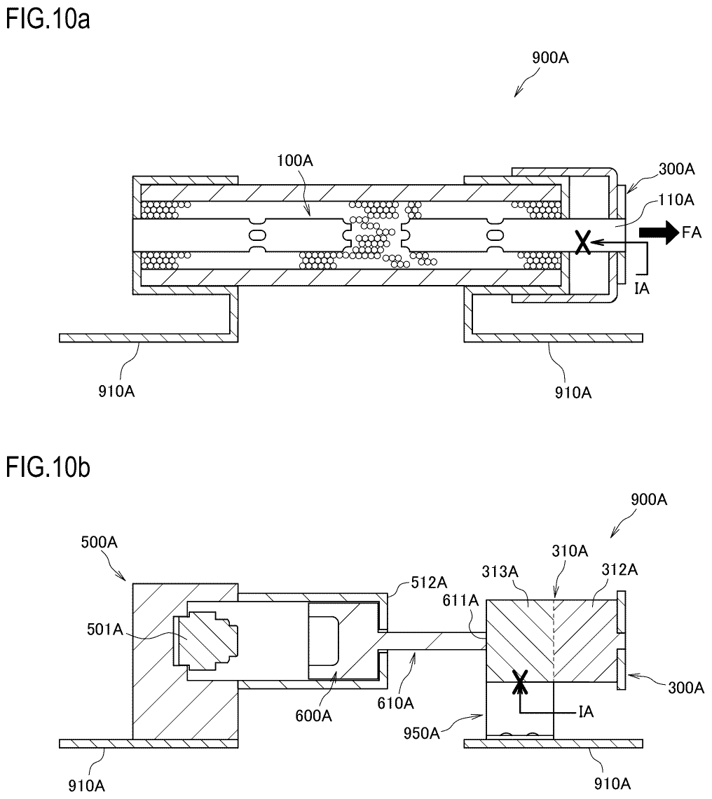

Next, with reference to FIGS. 9 and 10, a case will be described in which an external monitoring device detects that an abnormal current has flowed and inputs an abnormal signal to a power source 501A of the power mechanism 500A of the electric circuit breaker device 900A. FIG. 9 is a plan view illustrating a state in which the moving body 600A has moved from the state illustrated in FIG. 7, FIG. 10(a) is a cross-sectional view illustrating a state in which the fuse element 100A is divided from the state illustrated in FIG. 8(a), and FIG. 10(b) is a cross-sectional view illustrating a state in which the moving body 600A has moved from the state illustrated in FIG. 8(b).

As illustrated in FIGS. 9 and 10(b), when the moving body 600A moves toward the second end portion 512A by the power of the power source 501A, the distal end 611A of the protrusion 610A of the moving body 600A comes into contact with the slide portion 310A of the movable portion 300A. Then, the movable portion 300A is pressed by the moving body 600A, and the entire movable portion 300A moves laterally. When the movable portion 300A moves laterally, the end portion 110A of the fuse element 100A coupled to the movable portion 300A is pulled laterally. Then, the fuse element 100A is physically divided into left and right portions by the tensile force FA to cut off the overcurrent IA.

Further, as illustrated in FIG. 8, in a state before the fuse element 100A is pulled, the clamping plate 950A firmly clamps the conductive portion 312A of the slide portion 310A of the movable portion 300A to firmly maintain the state in which the fuse element 100A and the external connection terminal 910A are electrically connected. Further, as illustrated in FIGS. 8 to 10, even when the movable portion 300A moves and the end portion 110A of the fuse element 100A slides, the clamping plate 950A constituting the electrical connection maintaining structure firmly clamps the conductive portion 312A of the slide portion 310A of the movable portion 300A, and firmly maintains the state in which the fuse element 100A and the external connection terminal 910A are electrically connected. Therefore, the current IA flows from the external connection terminal 910A to the fuse element 100A via the clamping plate 950A and the movable portion 300A and can reliably and stably flow in the electric circuit until the end portion 110A of the fuse element 100A starts to move and the arc generated by dividing the fuse element 100A is extinguished.

Further, as shown in FIG. 10(b), after the fuse element 100 is divided, the insulating portion 313A of the slide portion 310A is replaced with the conductive portion 312A, and is positioned and sandwiched between the clamping plates 950A. Therefore, since the overcurrent IA (fault current) flowing from the external connection terminal 910A and the clamping plate 950A is cut off by the insulating portion 313A, the arc generated immediately after the fuse element 100 is cut off can be quickly extinguished. Note that the slide portion 310A includes the conductive portion 312A and the insulating portion 313A, but the present invention is not limited thereto, and the slide portion 310A may not include the insulating portion 313A and may be entirely formed of the conductive portion 312A.

### Third Embodiment

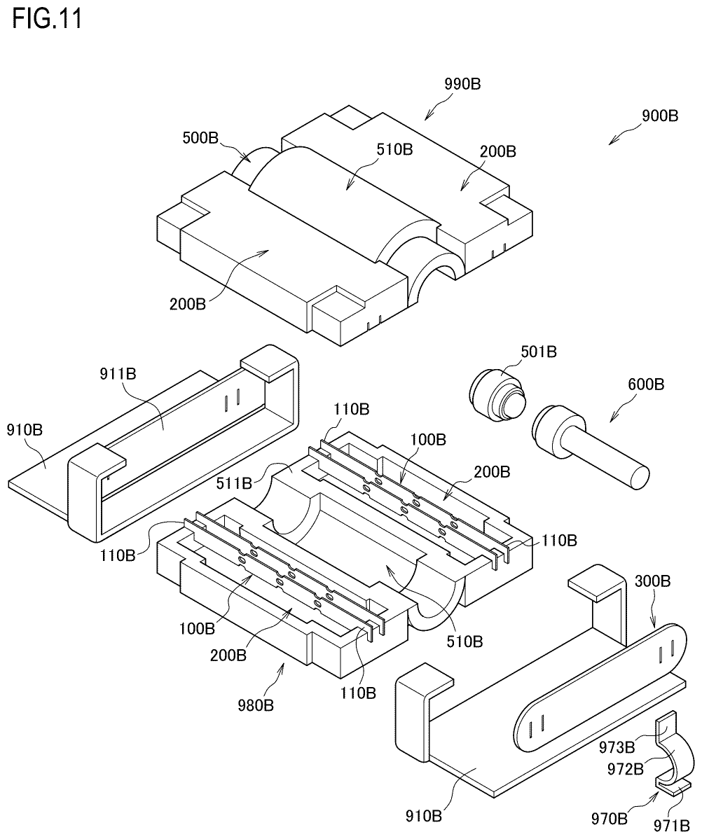

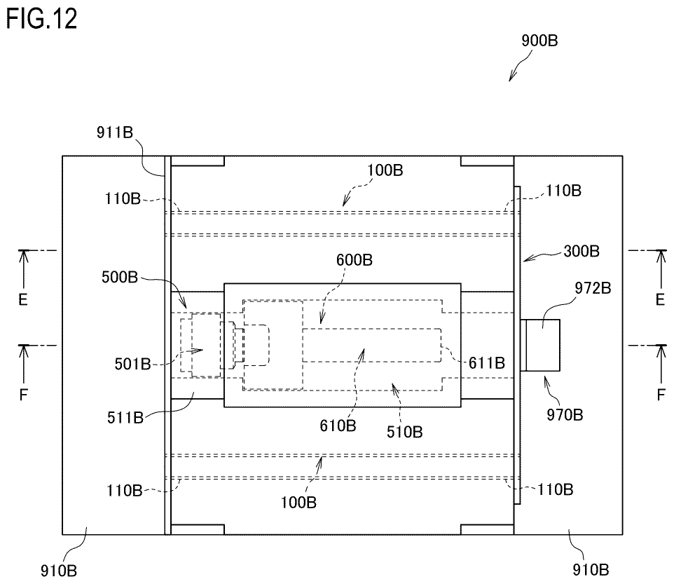

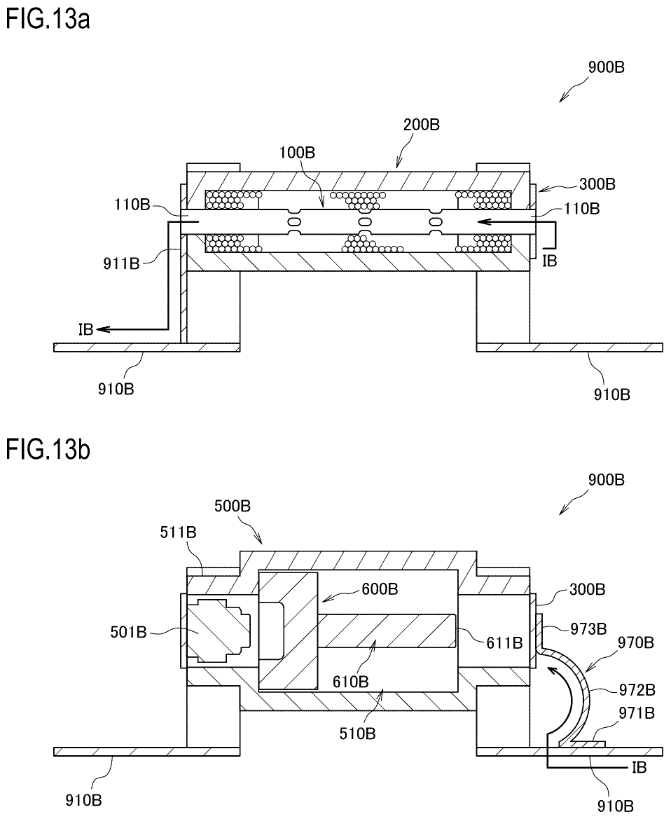

Next, an electric circuit breaker device 900B of the present invention according to the third embodiment will be described with reference to FIGS. 11 to 13. Note that FIG. 11 is an overall perspective view illustrating the electric circuit breaker device 900B in an exploded state, FIG. 12 is a plan view of the electric circuit breaker device 900B in an assembled state, FIG. 13(a) is a cross-sectional view taken along line E-E of FIG. 12, and FIG. 13(b) is a cross-sectional view taken along line F-F of FIG. 12. In addition, the configuration of the electric circuit breaker device 900B according to the third embodiment is different from the configuration of the electric circuit breaker device 900 according to the first embodiment in that the configuration of the electrical connection maintaining structure is different, and an accommodation portion 200B and a power mechanism 500B are integrated. However, the other configurations are basically the same as the configuration of the electric circuit breaker device 900 according to the first embodiment, and thus, the description of the same configuration will be omitted.

As illustrated in FIG. 11, the electric circuit breaker device 900B includes a lower housing 980B and an upper housing 990B, and can be assembled in a state where a fuse element 100B and a moving body 600B are accommodated therein by vertically overlapping and fixing the lower housing 980B and the upper housing 990B. Specifically, the fuse element 100B is accommodated in the accommodation portion 200B vertically surrounded by the lower housing 980B and the upper housing 990B. In addition, in the power mechanism 500B, a power source 501B is fixed at the first end portion 511B, and the moving body 600B is accommodated in an accommodation portion 510B vertically surrounded by the lower housing 980B and the upper housing 990B. As described above, in the electric circuit breaker device 900B, the lower housing 980B and the upper housing 990B are vertically overlapped with each other, so that the accommodation portion 200B and the power mechanism 500B can be assembled in an integrated state, and thus the electric circuit breaker device 900B can be easily assembled.

One external connection terminal 910B (left side in the drawing) includes a connection plate 911B extending upward from the external connection terminal 910B, and the external connection terminal 910B is electrically connected to the connection plate 911B. The connection plate 911B of the one external connection terminal 910B is electrically and physically coupled and fixed to the one end portion 110B of the fuse element 100B.

The other external connection terminal 910B (right side in the drawing) includes a metal conductor portion 970B. The conductor portion 970B includes a proximal end portion 971B fixed to the external connection terminal 910B, a curved plastically deformable portion 972B, and a distal end portion 973B coupled and fixed to a movable portion 300B. The external connection terminal 910B and the conductor portion 970B are electrically connected, and the conductor portion 970B and the movable portion 300B are also electrically connected. Further, the movable portion 300B is electrically and physically coupled and fixed to the other end portion 110B of the fuse element 100B.

As will be described later, the plastically deformable portion 972B of the conductor portion 970B is a portion that is plastically deformable when the movable portion 300B slides laterally. Therefore, the conductor portion 970B constitutes an electrical connection maintaining structure that maintains an electrical connection between the fuse element 100B and the external connection terminal 910B. Since the conductor portion 970B does not return to the original shape after plastic deformation, the movable portion 300B coupled to the conductor portion 970B does not return to the original position before sliding.

The electric circuit breaker device 900B is attached to an electric circuit to be protected and used. Specifically, the external connection terminals 910B of the electric circuit breaker device 900B at both sides are connected to part of the electric circuit. In the normal state, a current IB flowing from the electric circuit flows from the external connection terminal 910B to the conductor portion 970B as illustrated in FIG. 13(b). Since the conductor portion 970B and the movable portion 300B are electrically connected, the current IB reliably flows from the external connection terminal 910B to the movable portion 300B via the conductor portion 970B. As illustrated in FIG. 13(a), since the movable portion 300B and the end portion 110B of the fuse element 100B are fixed, the current IB flows from the movable portion 300B to the end portion 110B of the fuse element 100B. Then, the current IB flows from one end portion 110B to the other end portion 110B of the fuse element 100B, and flows from the other end portion 110B to the external connection terminal 910B via the connection plate 911B.

In this way, the current IB flows in the electric circuit via the electric circuit breaker device 900B. In the normal state, the power mechanism 500B does not operate, and a moving body 600B does not move. Therefore, a distal end 611B of a protrusion 610B of the moving body 600B is not in contact with the movable portion 300B and is in a separated state.

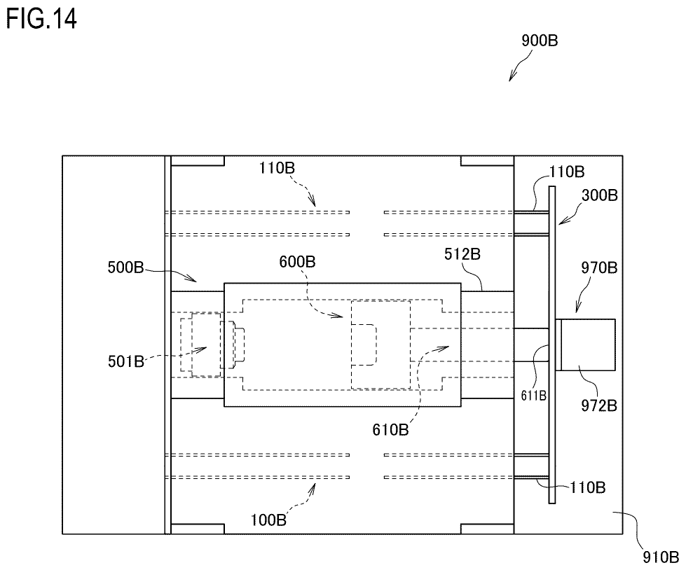

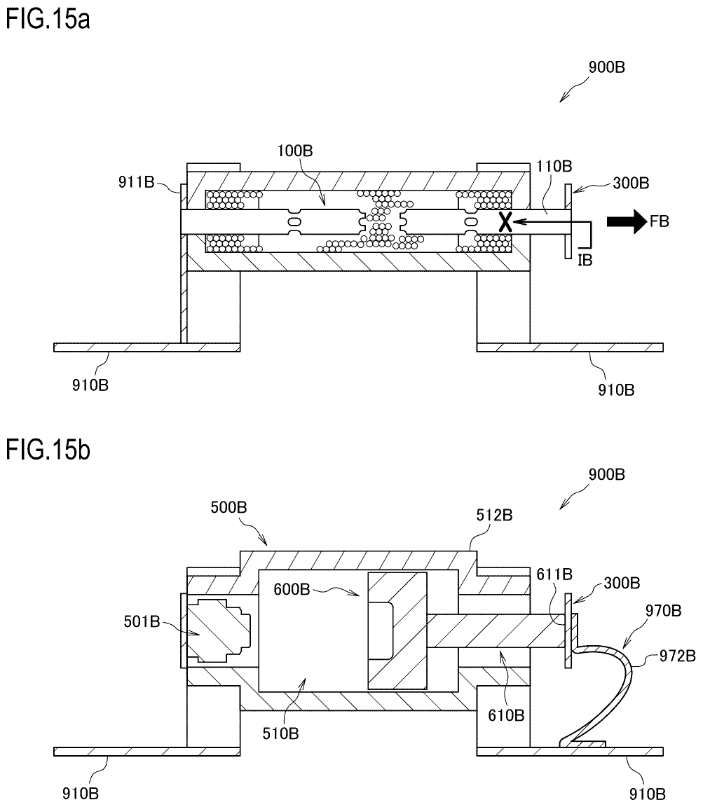

Next, with reference to FIGS. 14 and 15, a case where an external monitoring device detects that an abnormal current has flowed and inputs an abnormal signal to the power source 501B of the power mechanism 500B of the electric circuit breaker device 900B will be described. FIG. 14 is a plan view illustrating a state in which the moving body 600B has moved from the state illustrated in FIG. 12, FIG. 15(a) is a cross-sectional view illustrating a state in which the fuse element 100B is divided from the state illustrated in FIG. 13(a), and FIG. 15(b) is a cross-sectional view illustrating a state in which the moving body 600B has moved from the state illustrated in FIG. 13(b).

As illustrated in FIGS. 14 and FIG. 15(b), when the moving body 600B moves toward a second end portion 512B, the distal end 611B of the protrusion 610B of the moving body 600B contacts the movable portion 300B. Then, the movable portion 300B is pressed by the moving body 600B, and the entire movable portion 300B moves laterally. When the movable portion 300B moves laterally, the end portion 110B of the fuse element 100B coupled to the movable portion 300B is pulled laterally. Then, the fuse element 100B is physically divided into left and right portions by the tensile force FB to cut off the overcurrent IB.

Further, as illustrated in FIGS. 13 to 15, while the movable portion 300B moves and the end portion 110B of the fuse element 100B slides, the conductor portion 970B constituting the electrical connection maintaining structure is plastically deformed, and the conductor portion 970B maintains a state of being electrically and physically coupled to the movable portion 300B and the external connection terminal 910B. Therefore, the current IB flows from the external connection terminal 910B to the fuse element 100B via the conductor portion 970B and the movable portion 300B, and can stably flow in the electric circuit until the end portion 110B of the fuse element 100B starts to move and the arc generated by dividing the fuse element 100B is extinguished. Note that the conductor portion 970B is plastically deformable, but the present invention is not limited thereto. For example, the conductor portion 970B may be made of any material as long as the conductor portion 970B can be deformed so that the electrical connection between the external connection terminal 910B and the movable portion 300B can be maintained while the movable portion 300B moves.

### Fourth Embodiment

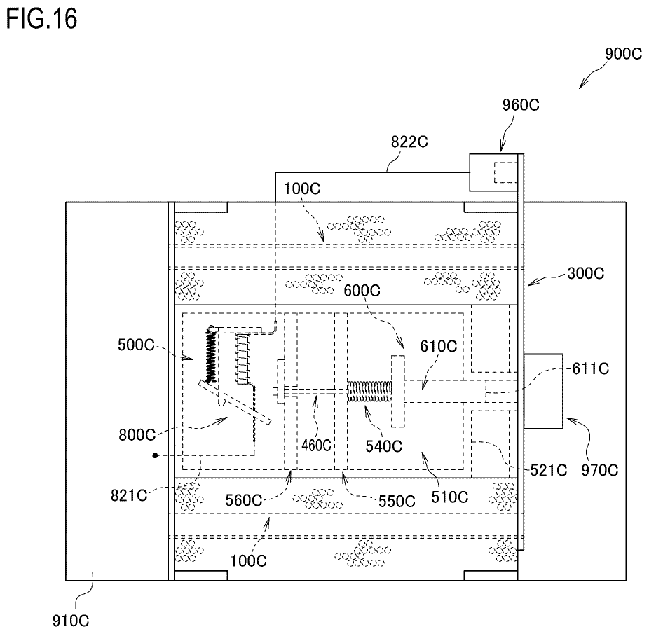

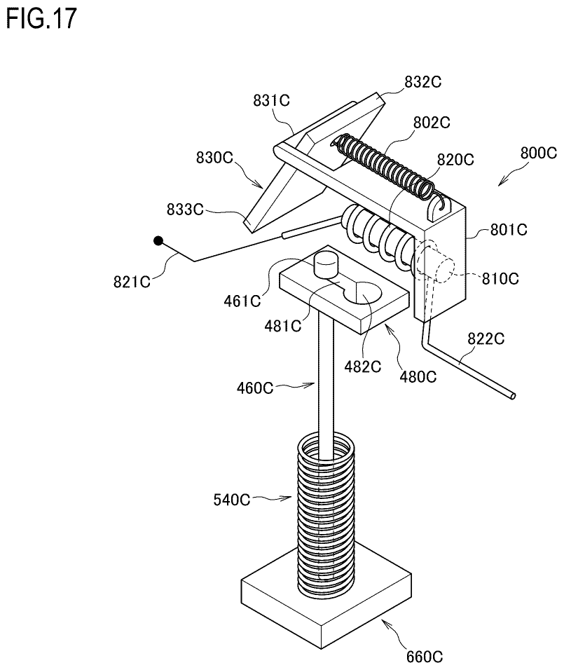

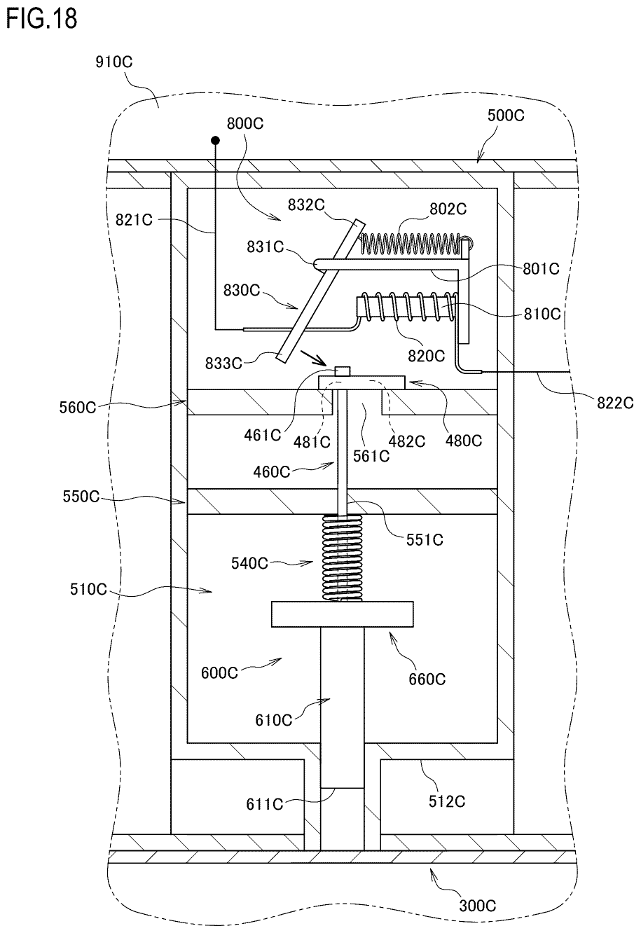

Next, an electric circuit breaker device 900C of the present invention according to the fourth embodiment will be described with reference to FIGS. 16 and 17. FIG. 16 is a plan view of the electric circuit breaker device 900C, FIG. 17 is an overall perspective view of an electromagnetic coil type tripping device 800C of a power mechanism 500C, and FIG. 18 is an enlarged plan view of the power mechanism 500C and a moving body 600C of the electric circuit breaker device 900C. In addition, the configuration of the electric circuit breaker device 900C according to the fourth embodiment is different from the configuration of the electric circuit breaker device 900B according to the third embodiment in the configurations of the power mechanism 500C and the moving body 600C, but the other configurations are basically the same as the configuration of the electric circuit breaker device 900B according to the third embodiment, and thus the description of the same configuration is omitted.

The power mechanism 500C according to the fourth embodiment includes the electromagnetic coil type tripping device 800C and a compression spring 540C instead of the power source 501B of the power mechanism 500B described in the third embodiment. The electromagnetic coil type tripping device 800C uses an existing principle used in the related art, and the configuration of the electromagnetic coil type tripping device 800C will be described in detail. Specifically, as illustrated in FIG. 17, the electromagnetic coil type tripping device 800C includes a fixed iron core 810C, a coil 820C wound around the fixed iron core 810C, and an operating iron piece 830C. As illustrated in FIG. 16, one end portion 821C of the coil 820C is electrically connected to one external connection terminal 910C. The other end portion 822C of the coil 820C is electrically connected to a movable portion 300C via a connector 960C.

As illustrated in FIGS. 17 and 18, the operating iron piece 830C is pivotally supported by a base 801C by a rotation shaft 831C, and the operating iron piece 830C can rotate about the rotation shaft 831C. Since an end 832C of the operating iron piece 830C is pulled by a tension spring 802C fixed to the base 801C, a distal end 833C opposite the end 832C is away from a head 461C of a shaft 460C.

The shaft 460C is coupled to a head 660C of the moving body 600C, and the shaft 460C is inserted through a through hole 551C of a first partition wall 550C and a through hole 561C of a second partition wall 560C of an accommodation portion 510C. The compression spring 540C is fitted to an outer periphery of shaft 460C, and the compression spring 540C is sandwiched and compressed between the first partition wall 550C and the head 660C of the moving body 600C. Therefore, a biasing force toward a second end portion 512C acts on the moving body 600C by the compression spring 540C.

The head 461C of the shaft 460C is locked to a fixing plate 480C fixed to the second partition wall 560C of the accommodation portion 510C. Specifically, the fixing plate 480C includes a locking hole 481C narrower than the head 461C and an insertion hole 482C wider than the head 461C. The locking hole 481C and the insertion hole 482C are continuous, and as will be described later, the state can be changed from a state where the head 461C is locked around the locking hole 481C to a state where the head 461C moves to the insertion hole 482C and the head 461C comes out of the insertion hole 482C downward.

In the normal state, the electromagnetic coil type tripping device 800C of the power mechanism 500C is not operated. Therefore, the force of biasing toward the second end portion 512C acts on the moving body 600C by the compression spring 540C, but the head 461C of the shaft 460C fixed to the moving body 600C is engaged with the fixing plate 480C, so that the moving body 600C does not move toward the second end portion 512C. Note that a distal end 611C of a protrusion 610C of the moving body 600C is not in contact with the movable portion 300C and is in a separated state.

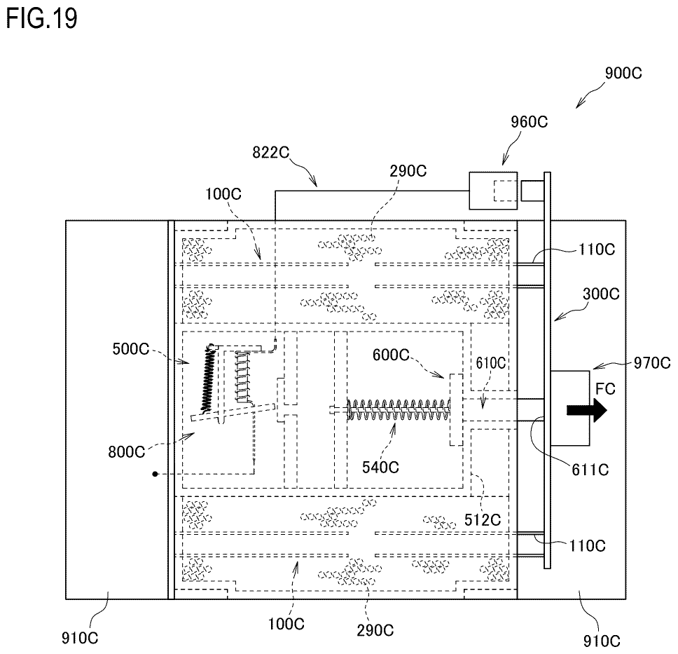

Next, a state in which the electric circuit breaker device 900C cuts off the electric circuit when an abnormality such as overcurrent flowing through the electric circuit occurs will be described with reference to FIGS. 18 and 19. Note that FIG. 19 is a plan view in which the moving body 600C has moved from the state illustrated in FIG. 16.

The overcurrent flowing from the electric circuit to the external connection terminal 910C flows from a conductor portion 970C to the movable portion 300C. Then, part of the overcurrent flows from the movable portion 300C to the coil 820C via the connector 960C. When the overcurrent flowing through the coil 820C exceeds a predetermined threshold value, the operating iron piece 830C is attracted to the fixed iron core 810C by the magnetic field generated in the fixed iron core 810C. Since the adsorption force at this time is stronger than the tensile force of the tension spring 802C, the operating iron piece 830C rotates about the rotation shaft 831C toward the fixed iron core 810C. Then, the distal end 833C of the operating iron piece 830C comes into contact with the head 461C of the shaft 460C, and moves the head 461C from the locking hole 481C to the insertion hole 482C.

When the head 461C of the shaft 460C comes out of the insertion hole 482C toward the through hole 561C, the engagement between the shaft 460C and the fixing plate 480C is released. Then, as illustrated in FIG. 19, the force of biasing toward the second end portion 512C acts on the moving body 600C by the compression spring 540C, so that the moving body 600C moves toward the second end portion 512C.

When the moving body 600C moves toward the second end portion 512C, the distal end 611C of the protrusion 610C of the moving body 600C contacts the movable portion 300C. Then, the movable portion 300C is pressed by the moving body 600C, and the entire movable portion 300C moves laterally. When the movable portion 300C moves laterally, an end portion 110C of a fuse element 100C coupled to the movable portion 300C is pulled laterally. Then, the fuse element 100C is physically divided into left and right portions by the tensile force FC to cut off the overcurrent. When the movable portion 300C moves laterally, the connector 960C connected to the coil 820C is detached from the movable portion 300C, and the coil 820C and the movable portion 300C are not electrically connected.

As described above, according to the electric circuit breaker device 900C of the present invention, it is not necessary to shear the arc-extinguishing material 290C together with the fuse element 100C since the fuse element 100C is divided by applying a tensile force to cut off the electric circuit. Therefore, as compared with the case where the part to be cut and the arc-extinguishing material are cut by the moving body as in the conventional electric circuit breaker device, the force for cutting the fuse element 100C may be small, and the power of the power mechanism for generating the tensile force may also be small. Specifically, according to the electric circuit breaker device 900C of the present invention, even when a plurality of fuse elements 100C is provided, only the force for dividing the fuse element 100C increases, and the area, of the arc-extinguishing material, to be sheared does not increase unlike the conventional electric circuit breaker device. Therefore, the power of the power mechanism for generating the tensile force can be reduced, as compared with the conventional electric circuit breaker device. As a result, according to the electric circuit breaker device 900C of the present invention, it is possible to suppress an increase in power of a power source and easily cut the electric circuit while it is possible to cope with an increase in the number of parts to be cut (fuse elements).

### Fifth Embodiment

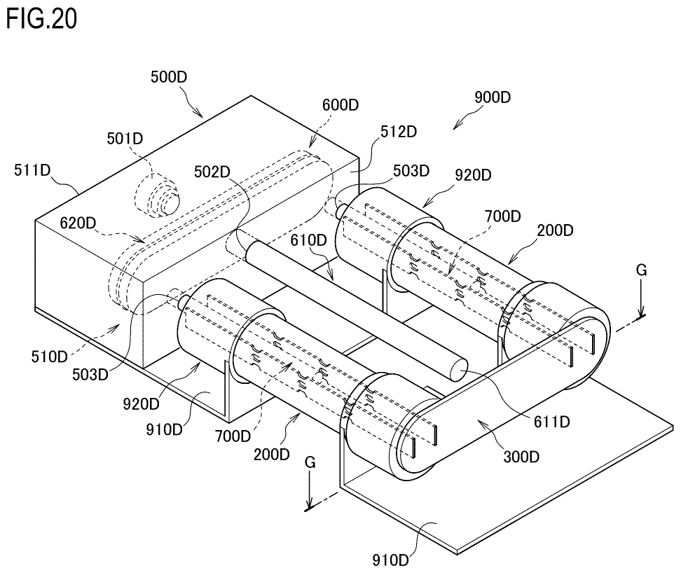

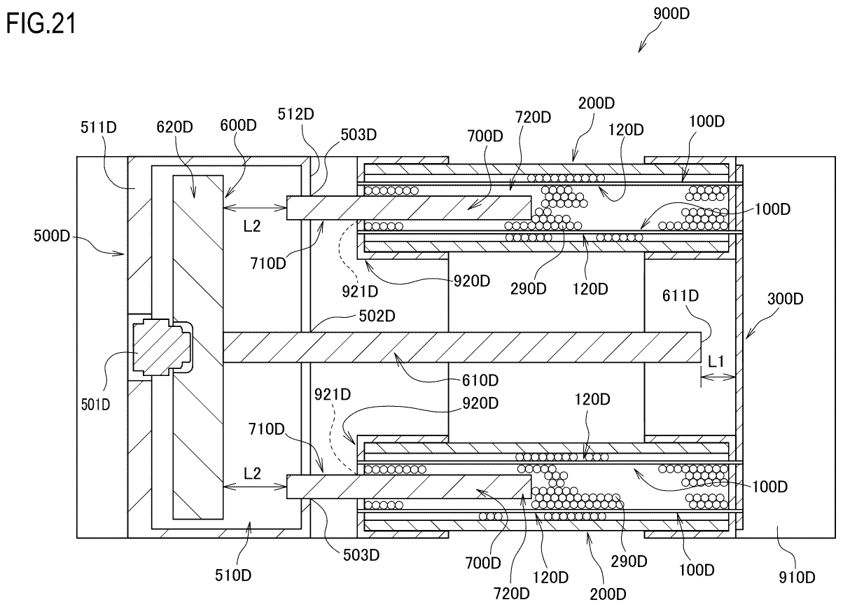

Next, an electric circuit breaker device 900D of the present invention according to the fifth embodiment will be described with reference to FIGS. 20 and 21. FIG. 20 is an overall perspective view of the electric circuit breaker device 900D, and FIG. 21 is a cross-sectional view taken along line G-G of FIG. 20. In addition, the configuration of the electric circuit breaker device 900D according to the fifth embodiment is different from the configuration of the electric circuit breaker device 900 according to the first embodiment in that a fastening portion 700D is provided and the shapes of a power mechanism 500D and a moving body 600D are different, but the other configurations are basically the same as those of the electric circuit breaker device 900 according to the first embodiment, and thus the description of the same configurations is omitted.

The power mechanism 500D has the same basic configuration as the power mechanism 500 of the electric circuit breaker device 900 according to the first embodiment, but is different in shape from the power mechanism 500 according to the first embodiment. Specifically, the power mechanism 500D is a substantially rectangular parallelepiped formed of an insulator such as synthetic resin, and includes an accommodation portion 510D capable of accommodating the moving body 600D therein, and a power source 501D is provided at a first end portion 511D of the accommodation portion 510D. In addition, an insertion hole 502D is provided at a second end portion 512D of the accommodation portion 510D, and a protrusion 610D of the moving body 600D is inserted. Furthermore, an insertion hole 503D is provided at the second end portion 512D of the accommodation portion 510D, and the fastening portion 700D is inserted therethrough. A sliding portion 620D of the moving body 600D has a large lateral width, and when the moving body 600D moves toward the second end portion 512D, the sliding portion 620D can come into contact with the fastening portion 700D to move the fastening portion 700D.

The fastening portion 700D is a long rod-shaped body formed of an insulator such as a synthetic resin, is accommodated in an accommodation portion 200D, and is disposed adjacent to a fuse element 100D. As illustrated in FIG. 21, a proximal end portion 710D of the fastening portion 700D passes through an insertion hole 921D of the cap 920 and extends to the power mechanism 500D. The proximal end portion 710D passes through the insertion hole 503D of the power mechanism 500D and protrudes into the accommodation portion 510D. On the other hand, a distal end portion 720D of the fastening portion 700D is adjacent to the periphery of a fusion portion 120D of the fuse element 100D. Since the fuse element 100D has a narrow width around the fusion portion 120D, the fuse element 100D is divided therearound when the fuse element 100D is pulled as described later.

In a normal state, the power mechanism 500D does not operate, and a moving body 600D does not move. Therefore, a distal end 611D of the protrusion 610D of the moving body 600D is not in contact with a movable portion 300D and is away by a distance L1. Further, the sliding portion 620D of the moving body 600D is not in contact with the proximal end portion 710D of the fastening portion 700D, and is away by a distance L2.

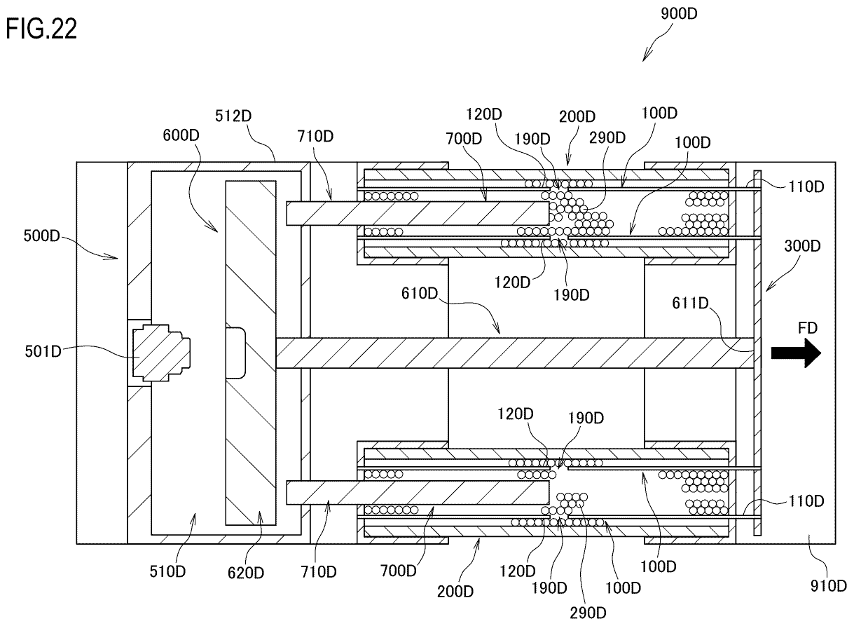

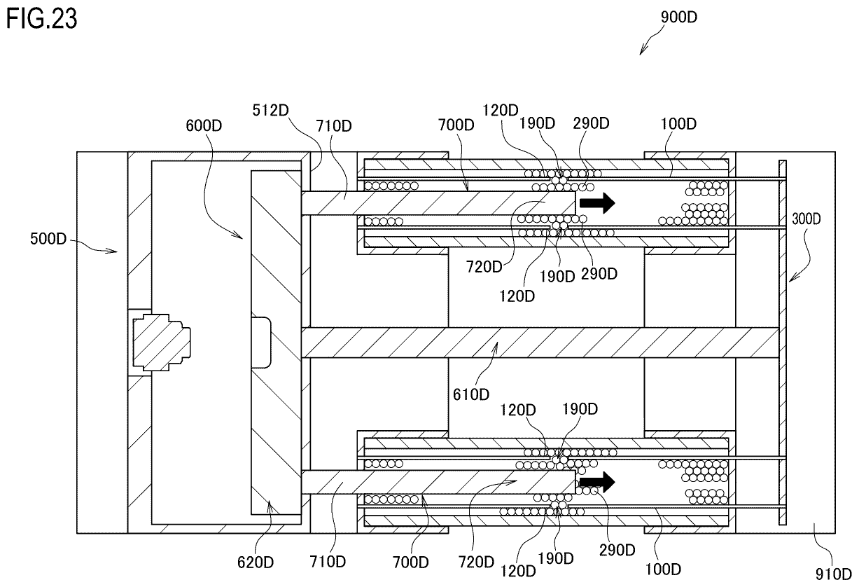

Next, with reference to FIGS. 22 and 23, a case where an external monitoring device detects that an abnormal current has flowed and inputs an abnormal signal to the power source 501D of the power mechanism 500D of the electric circuit breaker device 900D will be described. Note that FIG. 22 is a plan view illustrating a state in which the moving body 600D has moved from the state illustrated in FIG. 21, and FIG. 23 is a plan view illustrating a state in which the moving body 600D has further moved from the state illustrated in FIG. 22.

As illustrated in FIG. 22, when the moving body 600D moves toward the second end portion 512D, the distal end 611D of the protrusion 610D of the moving body 600D contacts the movable portion 300D. Then, the movable portion 300D is pressed by the moving body 600D, and the entire movable portion 300D moves laterally. When the movable portion 300D moves laterally, an end portion 110D of the fuse element 100D coupled to the movable portion 300D is pulled laterally. Then, the fuse element 100D is physically divided into left and right portions by the tensile force FD to cut off the overcurrent. The fuse element 100D has a locally narrow width near the fusion portion 120D, and is a division portion 190D to be divided by the tensile force FD.

As illustrated in FIG. 21, the accommodation portion 200D is filled with an arc-extinguishing material 290D, and the periphery of the fusion portion 120D before being divided is firmly filled with the arc-extinguishing material 290D. However, as illustrated in FIG. 22, when the periphery of the fusion portion 120D is divided, a cavity not filled with arc-extinguishing material 290D is formed in the periphery of division portion 190D. In the state illustrated in FIG. 22, the sliding portion 620D of the moving body 600D is not in contact with the proximal end portion 710D of the fastening portion 700D, and the fastening portion 700D is not moved.

Next, as illustrated in FIG. 23, when the moving body 600D further moves toward the second end portion 512D, the sliding portion 620D of the moving body 600D contacts the proximal end portion 710D of the fastening portion 700D. Then, the fastening portion 700D is pushed and moved by the sliding portion 620D, and the distal end portion 720D of the fastening portion 700D moves so as to be pushed toward the periphery of the division portion 190D. Therefore, the arc-extinguishing material 290D around the distal end portion 720D of the fastening portion 700D is pushed out so as to fill the cavity around the division portion 190D, and the arc-extinguishing material 190D is again fastened and fixed around the division portion 290D. As a result, when the fuse element 100D is divided to cut off the overcurrent, the arc generated around the division portion 190D can be effectively extinguished by the arc-extinguishing material 290D again fastened and fixed.

By adjusting the distance L1 and the distance L2 illustrated in FIG. 21, the movement timing and the movement distance of the fastening portion 700D can be appropriately changed. As a result, the timing, the force, and the amount for fastening and fixing the arc-extinguishing material 290D around the division portion 190D can be adjusted, so that the arc can be more efficiently extinguished. In addition, although the power source 501D is used as power for moving the moving body 600D, the present invention is not limited thereto, and the power mechanism 500D may include the electromagnetic coil type tripping device 800C and the compression spring 540C described in the fourth embodiment instead of the power source 501D.

### Sixth Embodiment

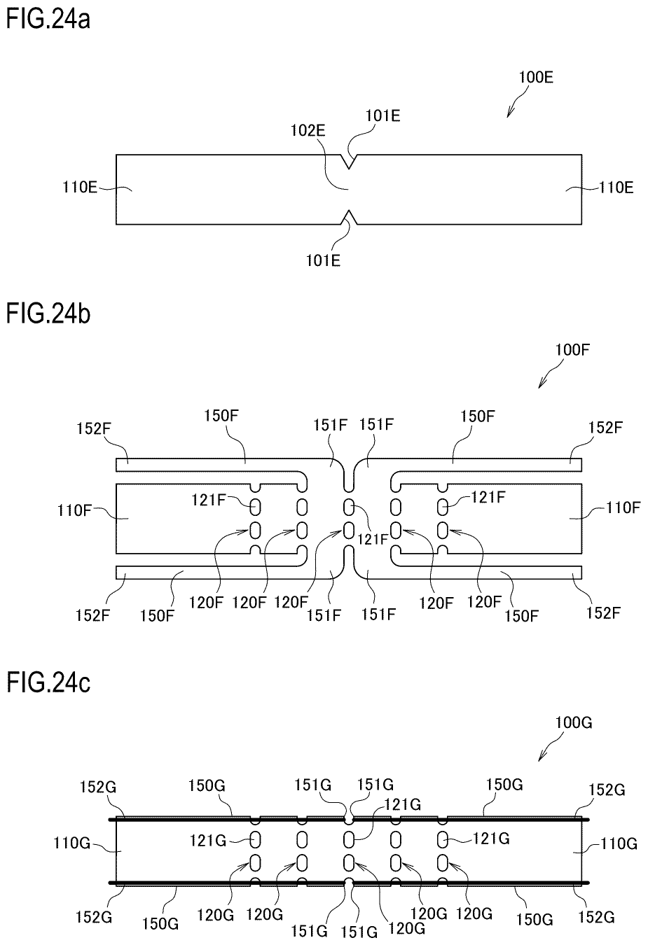

Next, a fuse element 100E of an electric circuit breaker device 900E of the present invention according to the sixth embodiment will be described with reference to FIG. 24(a). FIG. 24(a) is a side view of the fuse element 100E. Further, the configuration of the electric circuit breaker device 900E according to the sixth embodiment is different from the configuration of the electric circuit breaker device 900 according to the first embodiment in the configuration of the fuse element 100E, but the other configurations are basically the same as the configuration of the electric circuit breaker device 900 according to the first embodiment, and thus the description of the same configurations is omitted.

As shown in FIG. 24(a), the fuse element 100E does not include the fusion portion 120 of the fuse element 100 according to the first embodiment. By not including the fusion portion 120, the resistance of the fuse element 100E can be reduced, and the power loss can be suppressed so as to be low. Specifically, the fuse element 100E includes a single thin plate-shaped metal plate made of a metal conductor such as copper, and includes end portions 110E at both sides. Unlike the fuse element 100 according to the first embodiment, the fuse element 100E does not have a function of cutting off an overcurrent by blowing the fusion portion 120 when an overcurrent flows. However, when an abnormal current flows, the movable portion 300E moves laterally and the end portion 110E coupled to a movable portion 300E is pulled laterally, so that the fuse element 100E can be divided at an any position to cut off the overcurrent. Furthermore, a notch 101E may be provided at an any position of the fuse element 100E to form a narrow portion 102E that is more vulnerable than other portions to the external force. By providing the narrow portion 102E, the force when the end portion 110E is pulled laterally can be concentrated in the narrow portion 102E and divided, so that the division portion can be limited to a specific place as designed. This makes it possible to efficiently extinguish the arc generated at the time of dividing.

### Seventh Embodiment

Next, a fuse element 100F of an electric circuit breaker device 900F of the present invention according to the seventh embodiment will be described with reference to FIG. 24(b). FIG. 24(b) is a side view of the fuse element 100F. Further, the configuration of the electric circuit breaker device 900F according to the seventh embodiment is different from the configuration of the electric circuit breaker device 900 according to the first embodiment in the configuration of the fuse element 100F, but the other configurations are basically the same as the configuration of the electric circuit breaker device 900 according to the first embodiment, and thus the description of the same configurations is omitted.

As illustrated in FIG. 24(b), the fuse element 100F includes a single thin plate-shaped metal plate made of a metal conductor such as copper, and includes end portions 110F at both sides, a plurality of narrow portions (fusion portions) 120F located between the end portions 110F, and tension assisting portions 150F at both sides of the central narrow portion 120F. The narrow portion 120F has a plurality of small holes 121F in part of the fuse element 100F having a narrowed width to generate heat and blow when an unintended overcurrent flows in an electric circuit or the like to cut off the overcurrent. Further, a distal end 151F of the tension assisting portion 150F is coupled so as to be adjacent to the central narrow portion 120F. An end 152F of one tension assisting portion 150F is fixed to part of an accommodation portion 200F in which the fuse element 100F is accommodated, and an end 152F of the other tension assisting portion 150F is fixed to a movable portion 300F.

Then, when an abnormal current flows, the movable portion 300F moves laterally and the end portion 110F coupled to the movable portion 300F is pulled laterally, so that the vicinity of the narrow portion 120F at the center of the fuse element 100F is divided and an overcurrent can be cut off. At this time, since the central narrow portion 150F is pulled to both sides by the tension assisting portions 120F at both sides, the tensile force can be concentrated on the central narrow portion 120F rather than the other narrow portions 120F, and the central narrow portion 120F can be preferentially divided. As a result, the central narrow portion 120F can be limited as a division portion as designed, and the arc generated at the time of division can be efficiently extinguished. Note that, although the central narrow portion 120F is limited as the division portion, the present invention is not limited thereto, and when the tension assisting portions 120F are provided at both sides of the narrow portion 150F at an any position, the narrow portion 120F at the any position can be limited as the division portion.

### Eighth Embodiment

Next, a fuse element 100G of an electric circuit breaker device 900G of the present invention according to the eighth embodiment will be described with reference to FIG. 24(c). FIG. 24(c) is a side view of the fuse element 100G. Further, the configuration of the electric circuit breaker device 900G according to the eighth embodiment is different from the configuration of the electric circuit breaker device 900 according to the first embodiment in the configuration of the fuse element 100G, but the other configurations are basically the same as the configuration of the electric circuit breaker device 900 according to the first embodiment, and thus the description of the same configurations is omitted.

As illustrated in FIG. 24(c), the fuse element 100G includes a single thin plate-shaped metal plate made of a metal conductor such as copper, and includes end portions 110G at both sides and a plurality of narrow portions (fusion portions) 120G located between the end portions 110G. The narrow portion 120G has a plurality of small holes 121G in part of the fuse element 100G having a narrowed width to generate heat and blow when an unintended overcurrent flows in an electric circuit or the like to cut off the overcurrent. Further, tension assisting portions 150G are attached to both sides of the central narrow portion 120G. The tension assisting portion 150G is an inorganic string-like body, and a distal end 151G of the tension assisting portion 150G is coupled so as to be adjacent to the central narrow portion 120G. An end 152G of one tension assisting portion 150G is fixed to part of the accommodation portion 200G in which the fuse element 100G is accommodated, and an end 152G of the other tension assisting portion 150G is fixed to a movable portion 300G. The tension assisting portion 150G is in a state of being stretched so as not to be bent, and the tension assisting portion 150G is made of a material that does not stretch when the fuse element 100G is pulled.

Then, when an abnormal current flows, the movable portion 300G moves laterally and the end portion 110G coupled to the movable portion 300G is pulled laterally, so that the vicinity of the central narrow portion 120G of the fuse element 100G is divided and an overcurrent can be cut off. At this time, since the central narrow portion 120G is pulled to both sides by the tension assisting portions 150G at both sides, the tensile force can be concentrated in the central narrow portion 120G rather than in the other narrow portions 120G and preferentially divided. As a result, the central narrow portion 120G can be limited as a division portion as designed, and the arc generated at the time of division can be efficiently extinguished. Note that, although the central narrow portion 120G is limited as the division portion, the present invention is not limited thereto, and when the tension assisting portions 150G are provided at both sides of the narrow portion 120G at an any position, the narrow portion 120G at the any position can be limited as the division portion. In addition, the tension assisting portion 150G is not limited to the inorganic string-like body, and may have any shape made of any material as long as both sides of the narrow portion 120G at any place can be pulled.

### Ninth Embodiment

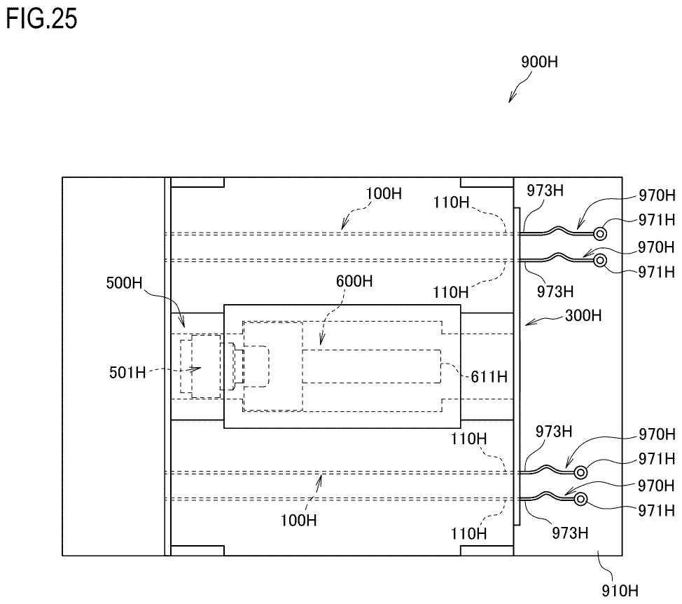

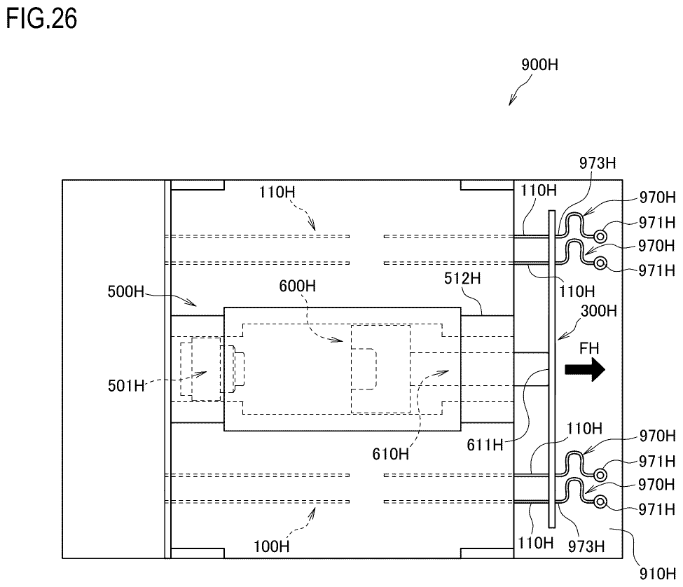

Next, an electric circuit breaker device 900H of the present invention according to the ninth embodiment will be described with reference to FIGS. 25 and 26. FIG. 25 is a plan view of the electric circuit breaker device 900H, and FIG. 26 is a plan view illustrating a state in which a moving body 600H has moved from the state illustrated in FIG. 25. In addition, the configuration of the electric circuit breaker device 900H according to the ninth embodiment is different from the configuration of the electric circuit breaker device 900B according to the third embodiment in the configuration of a conductor portion 970H constituting the electrical connection maintaining structure and the configuration of a movable portion 300H. However, the other configurations are basically the same as the configuration of the electric circuit breaker device 900B according to the third embodiment, and thus, the description of the same configuration is omitted.

As illustrated in FIG. 25, the metal conductor portion 970H constituted by an electric wire has a proximal end portion 971H connected to the other external connection terminal 910H (right side in the drawing), and a distal end portion 973H electrically and physically coupled and fixed to an end portion 110H of a fuse element 100H. A movable portion 300H is physically connected to the end portion 110H of each fuse element 100H, but the movable portion 300H is not electrically connected to the end portion 110H of each fuse element 100H because the movable portion 300H is made of an insulator such as resin.

As will be described later, the conductor portion 970H formed of an electric wire is deformable so as to be bent when the movable portion 300H slides laterally. Therefore, the conductor portion 970H constitutes an electrical connection maintaining structure that maintains an electrical connection between the fuse element 100H and the external connection terminal 910H.

Next, with reference to FIG. 26, a description will be given of a case where an external monitoring device detects that an abnormal current has flowed and inputs an abnormal signal to a power source 501H of a power mechanism 500H of the electric circuit breaker device 900H.

As illustrated in FIG. 26, when the moving body 600H moves toward a second end portion 512H, a distal end 611H of a protrusion 610H of the moving body 600H comes into contact with movable portion 300H. Then, the movable portion 300H is pressed by the moving body 600H, and the entire movable portion 300H moves laterally. When the movable portion 300H moves laterally, the end portion 110H of the fuse element 100H coupled to the movable portion 300H is pulled laterally. Then, the fuse element 100H is physically divided into left and right portions by the tensile force FH to cut off the overcurrent.

Further, while the movable portion 300H moves and the end portion 110H of the fuse element 100H slides, the conductor portion 970H constituting the electrical connection maintaining structure bends, but the conductor portion 970H maintains a state of being electrically and physically coupled to the end portion 110H of the fuse element 100H and the external connection terminal 910H. Therefore, the current flows from the external connection terminal 910H to the fuse element 100H through the conductor portion 970H, and can stably flow in the electric circuit until the end portion 110H of the fuse element 100H starts to move and the arc generated by dividing the fuse element 100H is extinguished.

The movable portion 300H is made of an insulator such as resin, but the present invention is not limited thereto, and it may be made of a conductor such as metal. Since the end portion 110H of each fuse element 100H can be pulled simultaneously with an equal tensile force whether the movable portion 300H is an insulator or a conductor, each fuse element 100H can be efficiently divided. In addition, the conductor portion 970H is configured by an electric wire that is deformable so as to be bent, but the present invention is not limited thereto. As long as the conductor portion 970H can be deformed so that the electrical connection between the external connection terminal 910H and the end portion 110H of the fuse element 100H can be maintained until the end portion 110H of the fuse element 100H is pulled and divided, the conductor portion 970H may have any form such as a bus bar having flexibility.

In addition, the electric circuit breaker device of the present invention is not limited to the above embodiment, and various modifications and combinations are possible within the scope of the claims and the scope of the embodiments, and these modifications and combinations are also included in the scope of the right.

In the claims:

1. An electric circuit breaker device comprising: an accommodation portion; external connection terminals at both sides; a fuse element accommodated in the accommodation portion; and an arc-extinguishing material, wherein
the electric circuit breaker device includes
a power mechanism configured to apply a tensile force to an end portion of the fuse element to divide the fuse element, and
an electrical connection maintaining structure that maintains an electrical connection between the fuse element and the external connection terminals until the fuse element is divided.

2. The electric circuit breaker device according to claim 1, further comprising:
a movable portion coupled to an end portion of the fuse element, wherein
the movable portion is moved by the power mechanism, and
the movable portion moved applies a tensile force to an end portion of the fuse element to divide the fuse element.

3. The electric circuit breaker device according to claim 2, wherein
the power mechanism includes a power source and a moving body that moves by power generated by the power source, and wherein
the moving body moves the movable portion.

4. The electric circuit breaker device according to claim 3, wherein
before the moving body moves, the moving body is away from the movable portion, and wherein
after the moving body starts to move, the moving body comes into contact with the movable portion, and the movable portion moves.

5. The electric circuit breaker device according to claim 2, wherein
the electrical connection maintaining structure includes facing clamping plates, and wherein
the movable portion includes a slide portion that is movable between the clamping plates while being clamped from by the clamping plates both sides and being electrically connected.

6. The electric circuit breaker device according to claim 5, wherein
the slide portion includes a conductive portion electrically connectable to the clamping plates and an insulating portion adjacent to the conductive portion, and wherein
the conductive portion is located between the clamping plates before the movable portion moves, and the insulating portion is located between the clamping plates after the movable portion moves.

7. The electric circuit breaker device according to claim 2, wherein
the electrical connection maintaining structure includes a plastically deformable conductor, and wherein
the conductor is coupled to the external connection terminal and the movable portion.

8. The electric circuit breaker device according to claim 1, wherein
the accommodation portion accommodates a fastening portion for fastening and fixing the arc-extinguishing material, and wherein
the power mechanism moves the fastening portion toward a periphery of a division portion of the fuse element to fasten and fix the arc-extinguishing material.

9. The electric circuit breaker device according to claim 1, wherein
the fuse element includes a narrow portion, and
includes a tension assisting portion that concentrates the tensile force in and divides the narrow portion.
